(19) United States
(12) Patent Application Publication
(10) Pub. No.: US 2018/0305247 A1
(43) Pub. Date: Oct. 25, 2018

(54) METHODS FOR TREATING A GLASS SURFACE TO REDUCE PARTICLE ADHESION

(71) Applicant: Corning Incorporated, Corning, NY (US)

(72) Inventors: Jiangwei Feng, Newtown, PA (US); James Patrick Hamilton, Horseheads, NY (US); Jhih-Wei Liang, Toufen City (TW)

(21) Appl. No.: 15/765,342

(22) PCT Filed: Sep. 29, 2016
(86) PCT No.: PCT/US16/54303

§ 371 Date: Apr. 2, 2018

Related U.S. Application Data
(60) Provisional application No. 62/236,302, filed on Oct. 2, 2015.

(51) Int. Cl. C03C 17/28; C03C 23/00

(52) U.S. Cl. CPC C03C 17/28; C03C 2217/91; C03C 23/0075; C03C 23/006

(57) ABSTRACT

Disclosed herein are methods for treating a glass substrate, comprising bringing a surface of the glass substrate into contact with a plasma comprising at least one hydrocarbon for a time sufficient to form a coating on at least a portion of the surface. Also disclosed herein are glass substrates comprising at least one surface, wherein at least a portion of the surface is coated with a layer comprising at least one hydrocarbon, wherein the coated portion of the surface has a contact angle ranging from about 15 degrees to about 95 degrees, and/or a surface energy of less than about 65 mJ/m².

This application claims the benefit of priority under 35 U.S.C. § 119 of U.S. Provisional Application Ser. No. 62/236,302 filed on Oct. 2, 2015, the content of which is relied upon and incorporated herein by reference in its entirety.

### FIELD OF THE DISCLOSURE

Disclosed herein are methods for treating a glass substrate to reduce the adhesion of particles to a surface of the glass substrate and, more particularly, methods for plasma passivation of a glass surface to produce glass substrates with improved resistance to contamination.

### BACKGROUND

Consumer demand for high-performance display devices, such as liquid crystal and plasma displays, has grown markedly in recent years due to the exceptional display quality, decreased weight and thickness, low power consumption, and increased affordability of these devices. Such high-performance display devices can be used to display various kinds of information, such as images, graphics, and text. High-performance display devices typically employ one or more glass substrates. The surface quality requirements for glass substrates, such as surface cleanliness, have become more stringent as the demand for improved resolution and image performance increases. The surface quality may be influenced by any of the glass processing steps, from forming the substrate to storage to final packaging.

Glass surfaces can have a high surface energy, due in part to the presence of surface hydroxyls (X—OH, X=cation), e.g., silanol (SiOH), on the glass surface. Surface hydroxyls can quickly form when the glass surface comes into contact with moisture in the air. Hydrogen bonding between the surface hydroxyl groups can induce further moisture absorption which can, in turn, lead to a viscous, hydrated layer comprising molecular water on the glass surface. Such a viscous layer can have various detrimental effects including, for example, a “capillary” effect that may induce stronger adhesion of particles on the glass surface and/or condensation of surface hydroxyls to form covalent oxygen bonds which can lead to stronger adhesion of particles to the surface, particularly at higher temperatures.

Glass substrates with high surface energy can attract particulates in the air during shipping, handling, and/or manufacturing. In addition, strong adhesion forces can lead to covalent bonding between the particles and the glass during storage, which can, in turn, result in decreased yield during the finishing and cleaning processes. In some instances, the longer a glass substrate has been stored, e.g., for several months, the harder it is to remove the particles from the surface due to potential covalent bonding between the particles and the glass surface.

Various potential methods for protecting against particle adhesion can include, for example, thermal evaporation, spray methods, or the use of coating transfer paper. However, such methods can be unreliable and/or inconsistent and can prove difficult and/or impractical to integrate into the glass finishing process. The surface protection may also itself introduce contaminants onto the glass surface, for example, organic compounds from deposited films or cellulosic particles from protective papers. Alternatively, some surface treatments may be difficult to remove when the end user seeks to clean and utilize the glass product. Accordingly, it would be advantageous to provide methods for reducing particle adhesion on a glass substrate that remedy one or more of the above deficiencies, e.g., methods that are more economical, practical, and/or more easily integrated into current glass forming and finishing processes. In some embodiments, the methods disclosed herein can be used to produce glass substrates that have low surface energy and improved handling and/or storage properties, such as reduced particle adhesion over a given storage time.

### SUMMARY

The disclosure relates, in various embodiments, to methods for treating a glass substrate, the methods comprising bringing a surface of the glass substrate into contact with a plasma comprising at least one hydrocarbon for a time sufficient to form a coating on at least a portion of the surface, wherein the coating has at least one of the following properties: (a) a surface energy of less than about 65 mJ/m²; (b) a polar surface energy of less than about 25 mJ/m²; (c) a dispersive surface energy of greater than about 10 mJ/m²; and (d) a contact angle with deionized water ranging from about 15 degrees to about 95 degrees.

Also disclosed herein are glass substrates comprising at least one surface, wherein at least a portion of the surface is coated with a layer comprising at least one hydrocarbon, wherein the coated portion of the surface has a contact angle with deionized water ranging from about 15 degrees to about 95 degrees. Further disclosed herein are glass substrates comprising at least one surface, wherein at least a portion of the surface is coated with a layer comprising at least one hydrocarbon, wherein the coated portion of the surface has a surface energy of less than about 65 mJ/m².

According to various embodiments, the plasma can be an atmospheric pressure, thermal or non-thermal plasma. The temperature of the plasma can range, for example from about 25° C. to about 300° C. In some embodiments, the plasma can comprise at least one hydrocarbon chosen from C₁-C₁₂ hydrocarbons, which may be linear branched or cyclic, such as C₁-C₆ volatile hydrocarbons and, optionally, at least one gas chosen from argon, helium, nitrogen, oxygen, air, hydrogen, water vapor, and combinations thereof, and at least one hydrocarbon. The at least one hydrocarbon may, in non-limiting embodiments, make up from about 1% to about 20% by volume of the plasma. The methods disclosed herein can, for example, passivate at least about 50% of surface hydroxyl groups on the glass surface. The methods disclosed herein can further comprise a step of cleaning the hydrocarbon coating off of the glass surface prior to end-use, for example, by wet or dry cleaning.

In further embodiments, the coated portion of the surface can have a surface energy of less than about 50 mJ/m², which can include a polar surface energy of less than about 25 mJ/m² and a dispersive energy of greater than about 10 mJ/m². In yet further embodiments, the glass substrate can be a substantially planar or non-planar glass sheet and can comprise, for instance, a glass chosen from aluminosilicate, alkali-aluminosilicate, alkali-free alkaline earth aluminosilicate, borosilicate, alkali-borosilicate, alkali-free alkaline earth borosilicate, aluminoborosilicate, alkali-aluminoborosilicate, and alkali-free alkaline earth aluminoborosilicate glasses. In certain embodiments, the coated portion of the surface can have a contact angle with deionized water ranging from about 15 to about 95 degrees and, after an optional washing step, can have a contact angle with deionized water of less than about 10 degrees.

Additional features and advantages will be set forth in the detailed description which follows, and in part will be readily apparent to those skilled in the art from that description or recognized by practicing the methods described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding, and are incorporated into and constitute a part of this specification. The drawings illustrate various non-limiting embodiments and together with the description serve to explain the principles and operations of the disclosure.

### BRIEF DESCRIPTION OF THE DRAWINGS

Various features, aspects and advantages of the present disclosure are better understood when the following detailed description is read with reference to the accompanying drawings wherein like structures are indicated with like reference numerals when possible, in which:

FIG. 1 illustrates and exemplary glass substrate with particles bound to the glass surface by hydrogen and covalent bonding;

FIG. 2 illustrates an exemplary glass substrate comprising a hydrocarbon layer in accordance with various embodiments of the disclosure, with a particle bound to the hydrocarbon surface by hydrogen bonding; and

FIG. 3 is a graphical depiction of surface energy as a function of the number of scans with a plasma;

FIGS. 4A-B are graphical depictions of particle count on a glass surface for various untreated and plasma-treated glass samples;

FIGS. 5A-B are graphical depictions of particle removal efficiency for various untreated and plasma-treated glass samples;

FIG. 6 is a graphical depiction of contact angle for glass substrates comprising a hydrocarbon layer after exposure to various acidic solutions; and

FIGS. 7A-B are graphical depictions of contact angle for glass substrates comprising a hydrocarbon layer after exposure to various temperatures.

### DETAILED DESCRIPTION

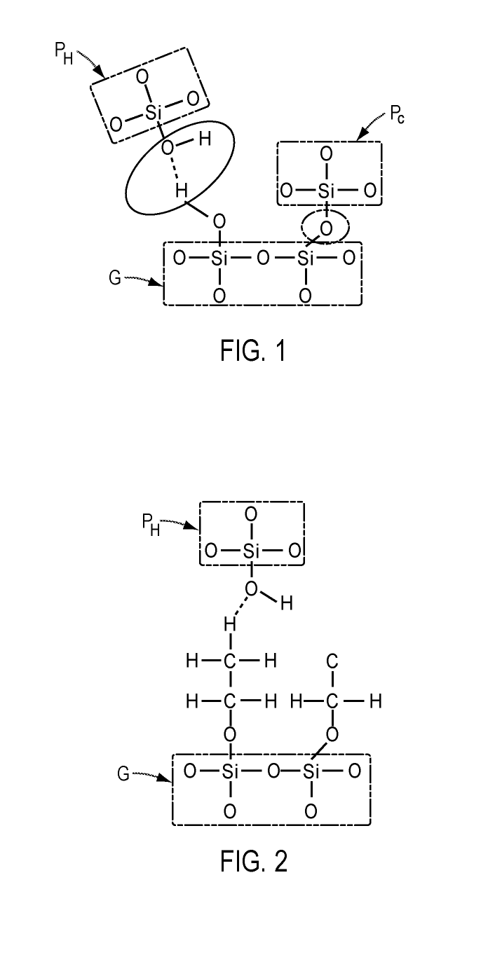

Drawn or cleaned glass surfaces can have a very high surface energy (as high as 90 mJ/m² in some cases). Such high surface energy can increase the susceptibility of the surface to particle adsorption from the air. Without wishing to be bound by theory, it is believed that the high surface energy is due at least in part to the presence of surface hydroxyl groups (X—OH), e.g., SiOH, AlOH, and/or BOH, on the glass surface, which can form hydrogen bonds with available particles. In addition, if a particle such as a glass or oxide particle remains adhered to the surface, the initial hydrogen bonding adhesion and/or van der Waals forces may be enhanced by condensation which can then lead to stronger covalent bonding. Particles that are covalently bound to the surface of the glass substrate can be even more difficult to remove, resulting in lower finishing yields. FIG. 1 demonstrates the surface of an exemplary glass sheet G, to which particles P_{H} and P_{C} are adhered by hydrogen bonding (circled with solid line) and by covalent bonding (circled with dashed line), respectively.

Glass particles of various sizes and shapes can be generated, e.g., by bottom-of-draw (BOD) traveling anvil machine (TAM) processing with either horizontal or vertical direction scoring and breaking, or by edge finishing, shipping, handling, and/or storage of the glass. In various industries, such particles are referred to as adhered glass (ADG). Adhesion and/or adsorption of particles to the glass surface can increase over time and can vary depending on changes in atmospheric conditions, such as temperature, humidity, cleanliness of the storage environment, and the like. Glass in storage for more than 3 months can be particularly susceptible to particle adhesion by high energy (e.g., covalent) bonds and can be difficult, if not impossible, to finish to an acceptable level that meets stringent quality control guidelines.

Methods

Disclosed herein are methods for treating a glass surface to reduce or eliminate the presence of surface hydroxyls on the glass surface and, thus, reduce or eliminate adhesion of particles to the glass surface due to covalent bonding induced by condensation. As used herein, the term “particle” and variations thereof is intended to refer to various contaminants of any shape or size adhered and/or adsorbed onto a glass surface. For instance, particles can include organic and inorganic contaminants, such as glass particles (e.g., ADG), cellulose fibers, dust, M-OX particles (M=metal; X=cation), and the like. Particles can be generated on the surface of a glass article during, e.g., the manufacture, transport, and/or storage of the glass article, such as during cutting, finishing, edge grinding, conveying (e.g., with suction cups, conveyor belts, and/or rollers), or storing (e.g., boxes, papers, etc.).

The methods disclosed herein comprise, for example, bringing the glass surface into contact with a plasma comprising at least one hydrocarbon for a time sufficient to form a coating on at least a portion of the glass surface. Referring to FIG. 2, the surface of a glass sheet G is depicted as coated with at least one hydrocarbon. The hydrocarbon layer can serve to passivate the glass surface, e.g., reduce or eliminate the amount of surface hydroxyls, e.g., SiOH, on the glass surface. Thus, any particles P_{H} that may adhere to the surface may do so by lower energy bonds such as hydrogen bonding, and covalently bound particles can be reduced or eliminated.

Treatment methods disclosed herein can, in some embodiments, passivate at least a portion of surface hydroxyl groups (X—OH) that may be present on the glass surface. As used herein, the term “passivation” and variations thereof is intended to refer to a treatment that neutralizes the surface hydroxyl groups, e.g., rendering them unavailable to react with particles or other potential reactants. Passivation can occur by chemisorption, such as covalent and ionic bonding, or by physisorption, such as hydrogen bonding and van der Waals interaction (see, e.g., FIG. 2, illustrating covalent bonding). According to various embodiments, the treatment methods can passivate at least about 25% of surface hydroxyl groups, such as at least about 30%, 35%, 40%, 45%, 50%, 55%, 60%, 65%, 70%, 75%, 80%, 85%, 90%, 95%, or 99%, e.g., ranging from about 25% to about 99%, including all ranges and subranges therebetween.

According to various embodiments, passivation is carried out by bringing a surface of the glass substrate into contact with a plasma. As used herein, the terms “contact” and “contacted” and variations thereof are intended to denote the physical interaction of the glass surface with the plasma. For instance, the plasma may be scanned over the surface of the glass substrate using any method or device known in the art, e.g., a plasma jet or torch, such that the surface comes into contact with one or more of the components making up the plasma, such as the at least one hydrocarbon component. As a result of the physical contact of the glass surface with the plasma, a chemical bond may form between the at least one hydrocarbon and at least one surface hydroxyl group (see, e.g., FIG. 2).

As used herein, the terms “plasma,” “atmospheric plasma,” and variations thereof are intended to denote a gas that passes through an incident high frequency electric field. Encountering the electromagnetic field produces ionization of the gas atoms and frees electrons which are accelerated to a high velocity and, thus, a high kinetic energy. Some of the high velocity electrons ionize other atoms by colliding with their outermost electrons and those freed electrons can in turn produce additional ionization, resulting in a cascading ionization effect. The plasma thus produced can flow in a stream and the energetic particles caught in this stream can be projected toward an object, e.g., the glass substrate.

The plasma can, in various embodiments, be an atmospheric pressure (AP) plasma and a thermal or non-thermal plasma. For example, the temperature of the plasma can range from room temperature (e.g., approximately 25° C.) to higher temperatures, such as up to about 300° C. By way of non-limiting example, the temperature of the plasma can range from about 25° C. to about 300° C., such as from about 50° C. to about 250° C., or from about 100° C. to about 200° C., including all ranges and subranges therebetween. The plasma can comprise at least one gas chosen from argon, helium, nitrogen, air, hydrogen, water vapor, and mixtures thereof, to name a few. According to some embodiments, argon can be employed as the plasma gas.

In non-limiting embodiments, the plasma can also comprise at least one hydrocarbon, which can be present in the form of a gas. Suitable hydrocarbons can include, but are not limited to, C₁-C₁₂ hydrocarbons, which may be linear, branched or cyclic, such as methane, ethane, propane, butane, pentane, hexane, heptane, octane, nonane, decane, undecane, dodecane, and combinations thereof, to name a few. According to various embodiments, volatile hydrocarbons with low boiling points (e.g., less than 100° C.) may be used, for example, C₁-C₆ hydrocarbons. In still further embodiments, the hydrocarbon can be methane, ethane, propane, or hexane. The plasma can comprise, for instance, from about 1% to about 20% by volume of the at least one hydrocarbon, such as from about 2% to about 18%, from about 3% to about 15%, from about 4% to about 12%, from about 5% to about 10%, or from about 6% to about 8%, including all ranges and subranges therebetween.

Contact between the plasma and the glass surface can be achieved using any suitable means known in the art, for example, a plasma jet or torch can be used to scan the surface of the glass substrate. The scan speed can be varied as necessary to achieve the desired coating density and/or efficiency for a particular application. For example, the scan speed can range from about 5 mm/s to about 100 mm/s, such as from about 10 mm/s to about 75 mm/s, from about 25 mm/s to about 60 mm/s, or from about 40 mm/s to about 50 mm/s, including all ranges and subranges therebetween.

The residence time, e.g. time period during which the plasma contacts the glass surface can likewise vary depending on the scan speed and the desired coating properties. By way of a non-limiting example, the residence time can range from less than a second to several minutes, such as from about 1 second to about 10 minutes, from about 30 seconds to about 9 minutes, from about 1 minute to about 8 minutes, from about 2 minutes to about 7 minutes, from about 3 minutes to about 6 minutes, or from about 4 minutes to about 5 minutes, including all ranges and subranges therebetween. In various embodiments, the glass surface can be contacted with the plasma in a single pass or, in other embodiments, multiple passes may be employed, such as 2 or more passes, 3 or more passes, 4 or more passes, 5 or more passes, 10 or more passes, 20 or more passes, and so on.

The methods disclosed herein may, in non-limiting embodiments, provide glass surface treatments that exhibit improved resistance to particle adhesion and/or improved removability of such particles from the glass surface. For instance, the removal efficiency for particles adhered to the glass surface after washing with water and/or mild detergents can be as high as 50%, such as greater than about 60%, greater than about 70%, greater than about 80%, greater than about 90%, greater than about 95%, or greater than about 99%, e.g., ranging from about 50% to about 99%, including all ranges and subranges therebetween. Exemplary washing techniques can include washing with a mild detergent solution such as Semi Clean KG and like detergents, for a time period ranging from about 15 seconds to about 5 minutes, such as from about 30 seconds to about 4 minutes, from about 45 seconds to about 3 minutes, from about 60 seconds to about 2 minutes, or from about 75 seconds to about 90 seconds, including all ranges and subranges therebetween. Non-limiting exemplary detergent concentrations can range from about 0.5 vol % to about 6 vol %, such as from about 1 vol % to about 5 vol %, from about 1.5 vol % to about 4 vol %, or from about 2 vol % to about 3 vol %, including all ranges and subranges therebetween. In some embodiments, washing may be carried out at room temperature or at elevated temperatures, such as from about 25° C. to about 80° C., from about 30° C. to about 75° C., from about 35° C. to about 70° C., from about 40° C. to about 65° C., from about 45° C. to about 60° C., or from about 50° C. to about 55° C., including all ranges and subranges therebetween.

Prior to contact with the plasma, the glass substrate can be processed using one or more optional steps, such as polishing, finishing, and/or cleaning the surface(s) or edge(s) of the glass substrate. Likewise, after contact with the plasma, the glass substrate can be further processed by these optional steps. Such additional steps can be carried out using any suitable methods known in the art. For instance, exemplary glass cleaning steps can include dry or wet cleaning methods. Cleaning steps can, in some embodiments, be carried out using Semi Clean KG, SC-1, UV ozone, and/or oxygen plasma, to name a few.

The plasma-treated glass substrate may, in some embodiments, be subjected to various finishing steps, such as edge finishing or edge cleaning processes. As such, in these embodiments, it may be desirable for the surface treatment to resist removal by water alone, e.g., as evidenced by little or no decrease in the contact angle of the surface with deionized water, as discussed in more detail below. Additionally, it may be desirable for the surface treatment to be easily removable with a detergent or using other cleaning steps outlined above, e.g., as evidenced by a decrease in contact angle with deionized water below about 10 degrees, as discussed in more detail below. Of course, the plasma-treated glass substrates may or may not exhibit one or all of these properties but are still intended to fall within the scope of the instant disclosure.

Glass Substrates

The disclosure also relates to glass substrates produced using the methods disclosed herein. For example, the glass substrates can comprise at least one surface, wherein at least a portion of the surface is coated with a layer comprising at least one hydrocarbon, wherein the coated portion of the surface has a contact angle with deionized water ranging from about 15 to about 95 degrees. In additional embodiments, the glass substrates can comprise at least one surface, wherein at least a portion of the surface is coated with a layer comprising at least one hydrocarbon, wherein the coated portion of the surface has a surface energy of less than about 65 mJ/m².

The glass substrate may comprise any glass known in the art including, but not limited to, aluminosilicate, alkali-aluminosilicate, alkali-free alkaline earth aluminosilicate, borosilicate, alkali-borosilicate, alkali-free alkaline earth borosilicate, aluminoborosilicate, alkali-aluminoborosilicate, alkali-free alkaline earth aluminoborosilicate, and other suitable glasses. In certain embodiments, the glass substrate may have a thickness of less than or equal to about 3 mm, for example, ranging from about 0.1 mm to about 2.5 mm, from about 0.3 mm to about 2 mm, from about 0.7 mm to about 1.5 mm, or from about 1 mm to about 1.2 mm, including all ranges and subranges therebetween. Non-limiting examples of commercially available glasses include, for instance, EAGLEXG®, Iris™, Lotus™, Willow®, and Gorilla® glasses from Corning Incorporated.

In various embodiments, the glass substrate can comprise a glass sheet having a first surface and an opposing second surface. The surfaces may, in certain embodiments, be planar or substantially planar, e.g., substantially flat and/or level. The glass substrate can be substantially planar or two-dimensional and, in some embodiments, can also be non-planar or three-dimensional, e.g., curved about at least one radius of curvature, such as a convex or concave substrate. The first and second surfaces may, in various embodiments, be parallel or substantially parallel. The glass substrate may further comprise at least one edge, for instance, at least two edges, at least three edges, or at least four edges. By way of a non-limiting example, the glass substrate may comprise a rectangular or square glass sheet having four edges, although other shapes and configurations are envisioned and are intended to fall within the scope of the disclosure. According to various embodiments, the glass substrate may have a high surface energy prior to treatment, such as up to about 80 mJ/m² or more, e.g., ranging from about 70 mJ/m² to about 90 mJ/m², or from about 75 mJ/m² to about 85 mJ/m².

The glass substrate can be coated with a layer comprising at least one hydrocarbon as described above with reference to the methods disclosed herein. The coating or layer can have a thickness ranging from about 1 nm to about 100 nm, such as from about 2 nm to about 90 nm, from about 3 nm to about 80 nm, from about 4 nm to about 70 nm, from about 5 nm to about 60 nm, from about 10 nm to about 50 nm, from about 20 nm to about 40 nm, or from about 25 nm to about 30 nm, including all ranges and subranges therebetween. As depicted in FIG. 2, the glass surface can be coated or passivated by the hydrocarbon layer. The presence of such a hydrocarbon layer can reduce or eliminate the presence of surface hydroxyl groups and thus reduce or prevent the occurrence of condensation and any resulting covalent bonding. Particles can, in various embodiments, bind to the hydrocarbon layer as depicted in FIG. 2; however, these bonds may be weaker bonds such as hydrogen bonds or van der Waals interactions.

As discussed above with respect to the method, the hydrocarbon layer may be produced by plasma deposition of at least one hydrocarbon, which may be chosen, for example, from linear, branched, or cyclic C₁₋₁₂ hydrocarbons. Without wishing to be bound by theory, it is believed that during plasma deposition the at least one hydrocarbon may be fully or partially decomposed and redeposited on the glass surface. In some embodiments, the hydrocarbon layer may comprise an amorphous hydrocarbon layer. In other embodiments, the hydrocarbon layer may comprise an amorphous hydrocarbon polymeric layer. In certain embodiments, a plasma comprising a given hydrocarbon precursor (e.g., C₁₋₁₂ hydrocarbon) may result in a hydrocarbon layer comprising at least a portion of shorter or longer hydrocarbons. Additionally, a plasma comprising a cyclic hydrocarbon precursor may result in a hydrocarbon layer comprising at least a portion of linear or branched hydrocarbons, and so on. Furthermore, a plasma comprising a given hydrocarbon precursor may result in a hydrocarbon film which is at least partially or fully polymerized.

After contact with the plasma, at least a portion of the glass surface may be coated with the hydrocarbon layer. In certain embodiments, the entire glass surface can be coated with the hydrocarbon layer. In other embodiments, desired portions of the glass surface can be coated, such as, for example, the edges or perimeter of the glass substrate, the central region, or any other region or pattern as desired, without limitation. The coated portion of the glass surface may, in various embodiments, have an overall surface energy of less than about 65 mJ/m², such as less than about 60 mJ/m², less than about 55 mJ/m², less than about 50 mJ/m², less than about 45 mJ/m², less than about 40 mJ/m², less than about 35 mJ/m², less than about 30 mJ/m², or less than about 25 mJ/m², e.g., ranging from about 25 mJ/m² to about 65 mJ/m², including all ranges and subranges therebetween. The polar surface energy can be, for example, less than about 25 mJ/m², such as less than about 20 mJ/m², less than about 15 mJ/m², less than about 10, less than about 9, less than about 8, less than about 7, less than about 6, less than about 5, less than about 4, less than about 3, less than about 2, or less than about 1 mJ/m², e.g., ranging from about 1 mJ/m² to about 25 mJ/m², including all ranges and subranges therebetween. The dispersive energy of the coated portion can, in certain embodiments, be greater than about 10 mJ/m², such as greater than about 15 mJ/m², greater than about 20 mJ/m², greater than about 25 mJ/m², greater than about 30 mJ/m², greater than about 35 mJ/m², or greater than about 40 mJ/m², e.g., ranging from about 10 mJ/m² to about 40 mJ/m², including all ranges and subranges therebetween.

Surface tension (or surface energy) of a material can be determined by methods well known to those in the art including the pendant drop method, the du Nuoy ring method or the Wilhelmy plate method (Physical Chemistry of Surfaces, Arthur W. Adamson, John Wiley and Sons, 1982, pp. 28). Moreover, the surface energy of a material surface can be broken down into polar and nonpolar (dispersive) components by probing surfaces with liquids of known polarity such as water and diiodomethane and determining the respective contact angle with each probe liquid. Accordingly, one can determine the surface properties of an untreated (control) glass substrate as well as the surface properties of a glass substrate treated with hydrocarbon plasma by measuring, e.g., water and diiodomethane control angles of each substrate using any one of the surface tension methods described above, alone or in conjunction with the following formula:

σ_{T}=σ_{D}+σ_{P},

where σ_{T} is the overall surface energy, σ_{D} is the dispersive surface energy, and σP is the polar surface energy.

According to various embodiments, after contact with the plasma, the coated portion of the glass may have a contact angle with deionized water ranging from about 15 degrees to about 95 degrees, such as from about 20 degrees to about 90 degrees, from about 25 degrees to about 85 degrees, from about 30 degrees to about 80 degrees, from about 35 degrees to about 75 degrees, from about 40 degrees to about 70 degrees, or from about 50 degrees to about 60 degrees, including all ranges and subranges therebetween. The hydrocarbon layer can also, in certain embodiments, be removed from the glass substrate as desired, e.g., prior to finishing the substrate for end-use application.

As discussed above with respect to the methods disclosed herein, wet and/or dry cleaning methods can be used to remove the hydrocarbon layer. After cleaning, the contact angle of the previously coated surface (with deionized water) can be greatly reduced, e.g., to as low as 0 degrees. For instance, the contact angle (with deionized water) when coated can be as high as about 95 degrees and, after cleaning, the contact angle (with deionized water) can be less than about 20 degrees, such as less than about 15 degrees, less than about 10 degrees, less than about 5 degrees, less than about 3 degrees, less than about 2 degrees, or less than about 1 degree, e.g., ranging from about 1 degree to about 20 degrees, including all ranges and subranges therebetween.

Furthermore, the hydrocarbon layer may, in some embodiments, exhibit a moderate resistance to removal by water alone, which can be useful if the coated substrate is to be subjected to various finishing steps, such as edge finishing or edge cleaning, before its end use. As such, in these embodiments, the contact angle of the coated surface (with deionized water), after contact with water (e.g., for a period of up to about 5 minutes), may be greater than about 15 degrees, such as greater than about 20, 25, 30, 35, 40, 45, 50, 55, 60, 65, 70, 75, 80, 85, 90, or 95 degrees, e.g., ranging from about 15 to about 95 degrees, including all ranges and subranges therebetween. In some embodiments, the contact angel of the coated surface (with deionized water), after contact with water (e.g., for a period of up to about 60 minutes), may be greater than about 15 degrees, such as greater than about 20, 25, 30, 35, 40, 45, 50, 55, 60, 65, 70, 75, 80, 85, 90, or 95 degrees, e.g., ranging from about 15 to about 95 degrees, including all ranges and subranges therebetween. Finally, the hydrocarbon layer may, in various embodiments, exhibit a moderate resistance to hot/humid environments, which can be useful if the coated substrate is stored in a warehouse without a controlled climate. As such, in these embodiments, the contact angle of the coated surface (with deionized water), after aging at 50° C. and 85% relative humidity (e.g., for a period of up to about 2 weeks), may be greater than about 15 degrees, such as greater than about 25, 30, 35, 40, 45, 50, 55, 60, 65, 70, 75, 80, 85, 90, or 95 degrees, e.g., ranging from about 15 to about 95 degrees, including all ranges and subranges therebetween. Of course, the plasma-treated glass substrates may or may not exhibit one or all of these properties but are still intended to fall within the scope of the instant disclosure.

Glass substrates and methods of the present disclosure may have at least one of a number of advantages over prior art substrates and methods. For example, methods disclosed herein may exhibit superior performance in terms of higher throughput, lower cost, and/or improved integratability, scalability, reliability, and or consistency as compared to prior art methods. Moreover, glass substrates treated according to such methods may have reduced particle adhesion, may be easier to clean, and/or may have improved performance over extended storage time periods. Of course, it is to be understood that the substrates and methods disclosed herein may not have one or more of the above characteristics but are still intended to fall within the scope of the disclosure and appended claims.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a hydrocarbon” includes examples having two or more such hydrocarbons unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a structure or method that comprises A+B+C include embodiments where a structure or method consists of A+B+C and embodiments where a structure or method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### Examples

Surface Energy

Corning EAGLE XG® glass substrates were subjected to various plasma treatments to evaluate the effect of residence time on surface energy. A linear plasma head was used to apply a methane coating to the glass coupons using two, four, or ten passes.

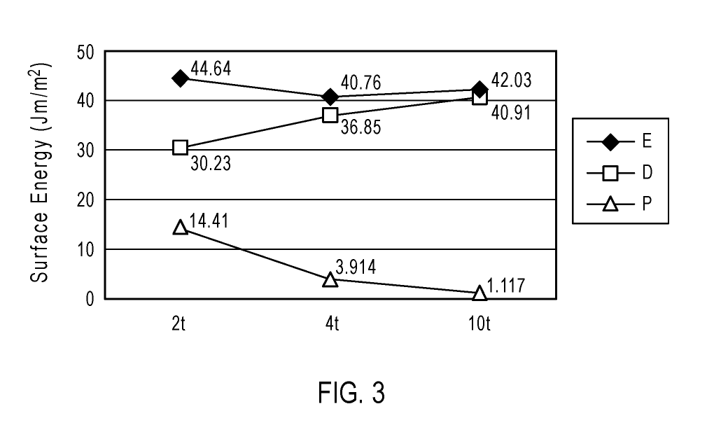

As shown in FIG. 3, the more contact a glass surface has with the plasma (e.g., higher residence time, more passes with the plasma jet, etc), the more effectively the surface is coated with the hydrocarbon layer, as indicated by surface energy measurements. Overall surface energy E generally tended to decrease with additional passes (e.g., increased plasma contact). Notably, the polar surface energy component P decreased with additional passes, whereas the dispersive surface energy component D increased with additional passes. Without wishing to be bound by theory, it is believed that polar surface energy decreases with additional passes because polarity is strongly affected by the concentration of hydroxyl groups on the glass surface, whereas the hydrocarbon coating itself does not have a significant polar group.

Contact Angle

Corning Eagle XG® glass substrates were subjected to various plasma treatments to evaluate the effect of residence time on contact angle for different hydrocarbon surface treatments. Glass samples were coated using different methods and the contact angle of the surface-treated glass substrates with deionized water was measured. The substrates were then rinsed in deionized water for 5 minutes and the contact angle measured again. Finally, the substrates were washed with an alkaline detergent at 50° C. in an ultrasonic bath and the contact angle measured once more. The results are illustrated in Table I below.

TABLE I
Contact Angle

| Plasma | | | | | Contact Angle (DIW) | | |
|---|---|---|---|---|---|---|---|
| | | | Scan | | | After | After |
| | | Power | Speed | | As | DIW | Det. |
| Run | Hydrocarbon | (W) | (mm/s) | Passes | Coated | Wash | Wash |
| M1 | Methane | 150 | 30 | 4 | 89.8 | 97.4 | 21.0 |
| M2 | Methane | 150 | 80 | 2 | 54.1 | 43.9 | 10.2 |
| M3 | Methane | 275 | 25 | 1 | 88.0 | 79.5 | 6.2 |
| M4 | Methane | 275 | 62.5 | 1 | 77.2 | 75.1 | 3.2 |
| P1 | Propane | 250 | 30 | 1 | 89.8 | 81.9 | 3.5 |
| P2 | Propane | 250 | 100 | 1 | 76.9 | 70.3 | 2.9 |
| H1 | Hexane | 450 | 30 | 2 | 87.5 | 83.2 | 8.4 |
| H2 | Hexane | 450 | 30 | 1 | 90.8 | 85.9 | 4.1 |

As demonstrated in Table I above, the glass samples comprising a hydrocarbon coating exhibit a relatively high contact angle with deionized water, indicating that the hydrophobicity, or resistance of the surface to water, was increased by the treatment (e.g., as compared to a contact angle of 10 degrees or less for untreated glass). A higher contact angle with deionized water tends to indicate that the surface is not easily wet by water and is thus more water-resistant. Water resistance was also demonstrated by the relatively high contact angle of the plasma-treated samples, even after washing with deionized water for 5 minutes. In some embodiments, it may be desirable to easily and quickly remove the surface treatment by washing. As shown in Table I above, after contacting the plasma-treated glass substrates with a detergent for 2 minutes, the contact angle of the substrates decreased significantly, which tends to indicate that the surface treatment was successfully removed. In some embodiments, a contact angle of less than about 10 can indicate a “clean” glass surface. Of course, the washing method, time, detergent, etc. can be varied to remove a desired amount of the surface treatment and/or obtain a desired level of surface cleanliness.

Particle Adhesion

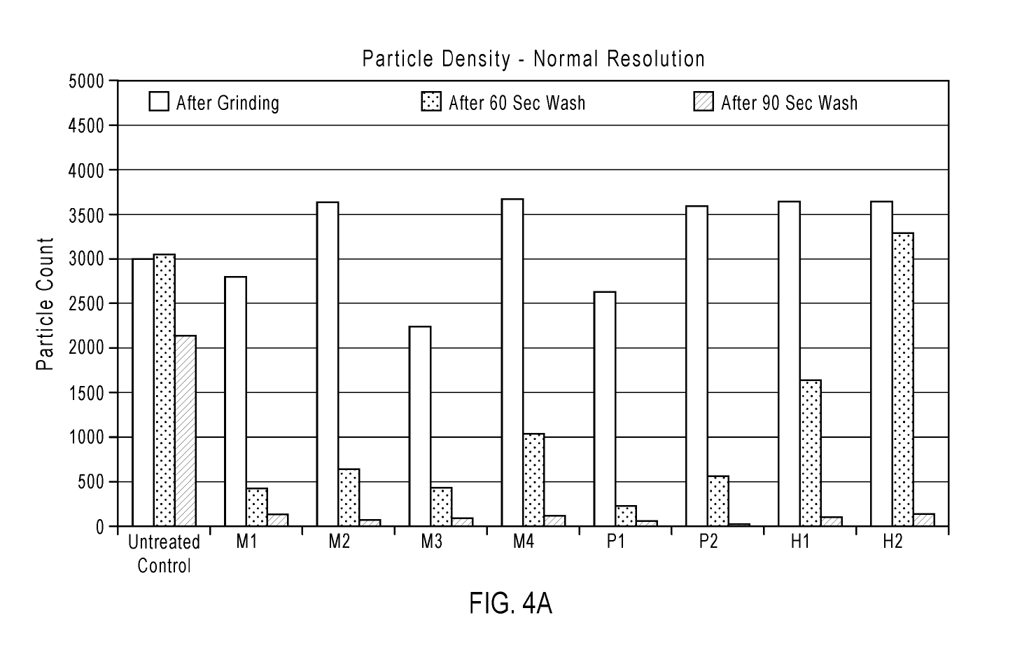

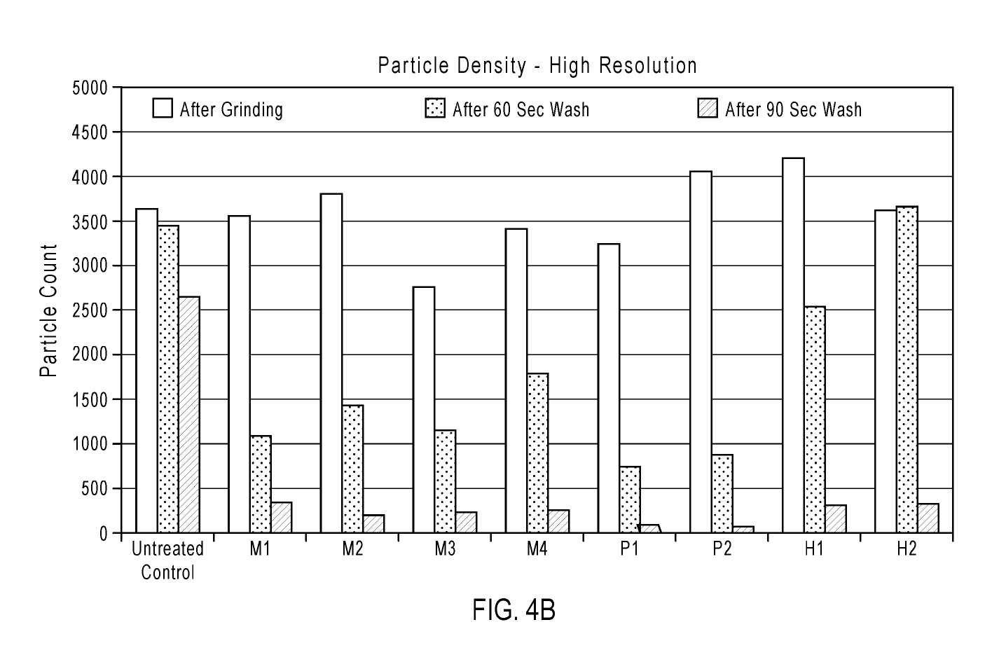

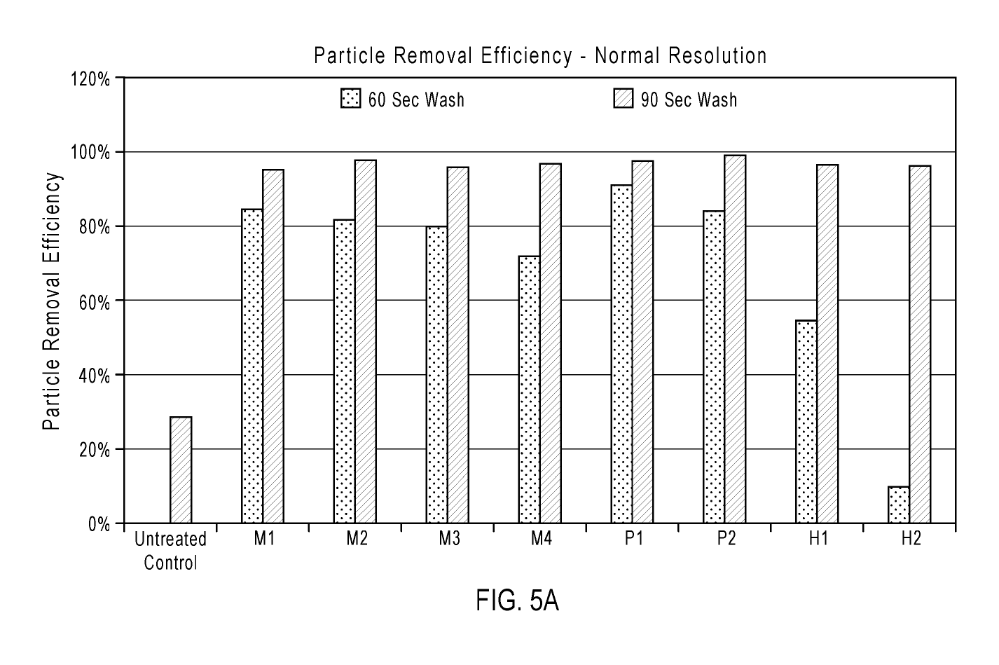

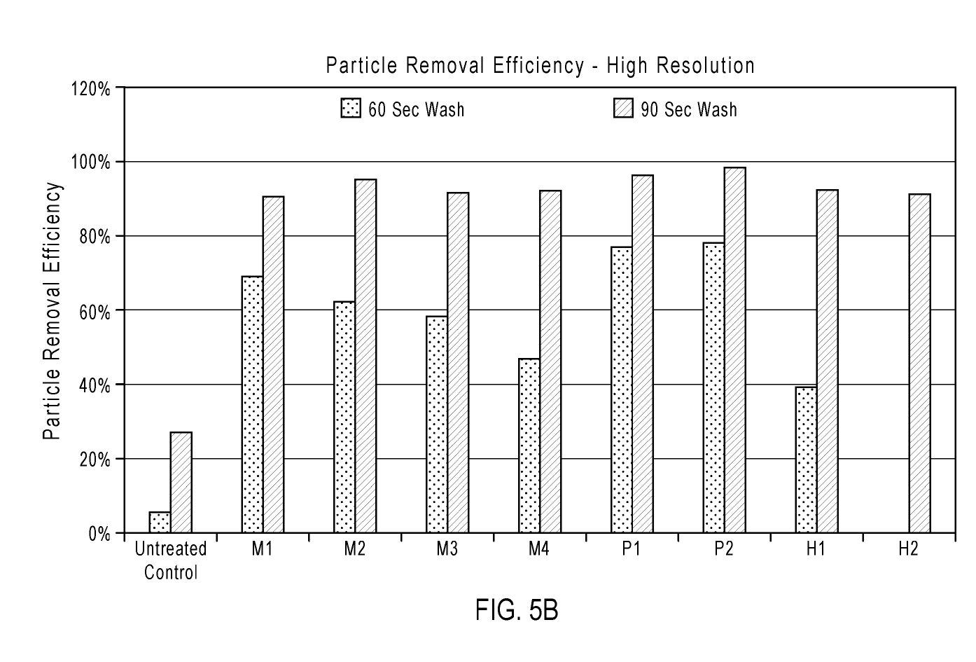

The plasma-treated glass samples, as well as untreated samples, were subjected to edge grinding and subsequent washing processes to assess the ability of the plasma coatings to protect a glass surface from glass particle adhesion and/or to facilitate the removal of any adhered particles by washing. The edges of the glass samples (4″×4″) were ground in a manner that generated glass particles which were flung onto the glass surface. A particle counter was then used to count the number of particles deposited on the glass surface by the edge grinding process. The glass samples were then washed with an alkaline detergent for either 60 or 90 seconds. The particles remaining on the glass surface after washing were then re-counted. The results of these tests are presented in FIGS. 4-5. Normal resolution counts particles having a diameter greater than 1 μm, whereas high resolution counts smaller particles having a diameter as low as 0.3 μm.

FIGS. 4A-B demonstrate substantially lower particle counts for all plasma-treated glass as compared to the untreated glass. Among the various plasma treatments, it appears that plasma treatments with methane, propane, and hexane performed more or less equally with respect to the number of particles deposited. With respect to the number of particles remaining after washing for 60 seconds, it appears that propane and methane plasma treatments perform relatively equally, and both of these treatments appear to outperform plasma treatment with hexane. However, after 90 seconds of washing, it appears that all plasma-treated samples performed more or less equally.

Referring to FIGS. 4A-B, as between the two propane plasma treatments, propane (P1) outperformed propane (P2), the latter using higher scan speeds. As between the two hexane plasma treatments, hexane (H1) outperformed hexane (H2), the latter using one less plasma jet pass. Similarly, methane (M3) outperformed methane (M4), which utilized higher scan speeds, and methane (M1) outperformed methane (M2), which utilized higher scan speeds and less plasma passes. Thus, without wishing to be bound by theory, it is believed that longer exposures to the plasma treatment can improve the resistance of the glass surface to particle adhesion and/or improve the removability of such particles from the surface upon washing.

Referring to FIGS. 5A-B, which demonstrate particle removal efficiency after washing, it appears that glass samples plasma treated with propane performed more or less equally as compared to glass samples plasma treated with methane, which both outperformed glass samples plasma treated with hexane, for samples washed for 60 seconds. After 90 seconds of washing, it appears that all plasma-treated samples performed more or less equally. In all instances, the plasma-treated samples significantly outperformed the untreated sample (both after 60 and 90 seconds of washing).

Surface Bonding

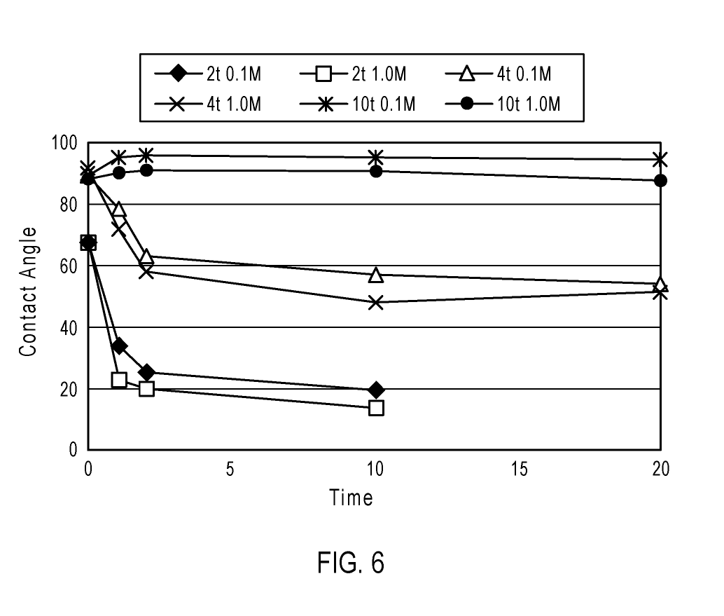

To assess how the hydrocarbon coating is bonded to the glass surface, CH₄ AP plasma-treated glass substrates were soaked in two different solutions (0.1M and 1M) of hydrochloric acid (HCl). If the glass-hydrocarbon bonding is Si—O—C, it is hypothesized that, at least in the case of hydrocarbons with shorter chains (e.g., C₄ or less), a hydrolysis reaction would occur upon exposure to either an acidic or basic solution. FIG. 6 illustrates the results of such an experiment with an acidic solution. Glass substrates scanned two or four times exhibited a fast and significant drop in contact angle upon exposure to both acidic solutions. This drop suggests that hydrolysis occurred and led to SiOH formation, potentially indicating that the glass surface bonds to the hydrocarbon layer via Si—O—C bonding, as depicted in FIG. 2. In contrast, for glass substrates scanned ten times with the plasma, the contact angle remained relatively constant, even after 20 minutes of exposure to the acidic solutions. Without wishing to be bound by theory, it is believed that the improved coverage obtained using 10 passes may lead to enhanced cross-linking between the hydrocarbon molecules which can, in turn, hinder hydrolysis under acidic conditions. However, it was also noted that in all cases the contact angle was not completely reduced to less than 5 degrees (lowest observed contact angle as around 20 degrees), which could indicate that there might be a small amount of Si—C bonding present at the glass-hydrocarbon interface.

Tables IIa-c below indicate the atomic concentrations, percentage of carbon, and percentage of silicon, respectively, for CH₄ AP plasma passivated glass substrates scanned four or ten times with the plasma (as determined by X-ray photoelectron spectroscopy (XPS)).

TABLE IIa
Atomic Concentration

| | B | C | N | O | Al | Si | Ca |
|---|---|---|---|---|---|---|---|
| 10 passes | 0.4 | 84.2 | 0.2 | 10.0 | 1.1 | 3.9 | 0.2 |
| 4 passes | 2.4 | 43.5 | 0.6 | 35.9 | 3.4 | 13.3 | 0.9 |

TABLE IIb
Percent Carbon

| | C—C, C—H | C—O |
|---|---|---|
| 10 passes | 94 | 6 |
| 4 passes | 91 | 9 |

TABLE IIc
Percent Silicon

| | Si | SiO₂ |
|---|---|---|
| 10 passes | 70 | 30 |
| 4 passes | 82 | 18 |

As shown in Tables IIa-c, more passes with the plasma resulted in higher C intensity and less Si intensity, as well as lower intensity for other glass components, such as Al, B, Ca, and O, which is indicative of a thicker carbon layer on the glass surface. XPS did not detect COO or N═H bonding, but did detect C—C, C—O, C—H, Si—O, and Si—C bonding. Silicon was detected, having an Si—O backbone with organic side groups attached to the silicon atoms possibly by Si—C or Si—O—C bonding, but XPS could not differentiate between or quantify the two peaks. Likewise, XPS could not discern between C—H and O—H bonding.

Thermal Durability

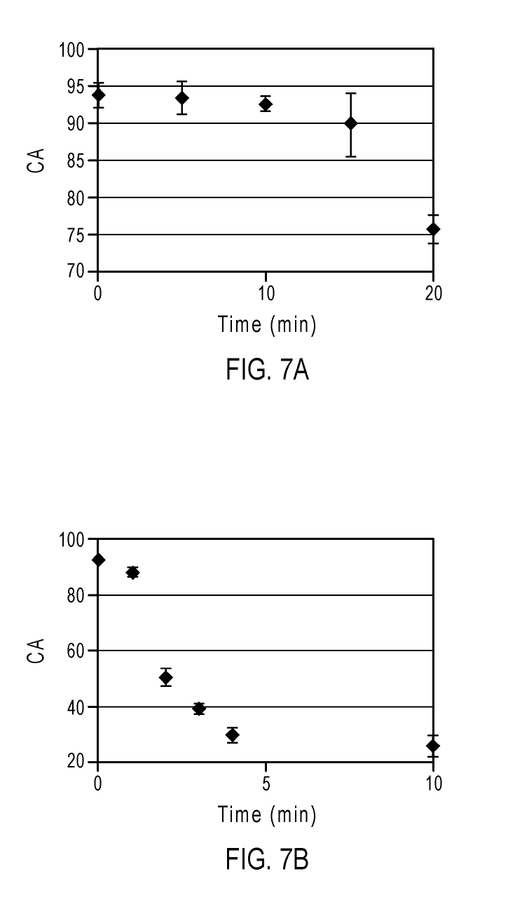

Referring to FIGS. 7A-B, which depict the durability of the hydrocarbon coating at high temperatures (300° C. and 400° C., respectively). FIG. 7A shows that the coating can withstand 300° C. temperatures for about 10 minutes or more. FIG. 7B indicates that the coating volatilizes relatively quickly at 400° C., lasting about 5 minutes or less. Thus, based on this data, it is believed that it may be feasible to incorporate hydrocarbon coating on glass substrates at elevated temperatures, perhaps even in the BOD area of the glass making process, depending on processing parameters.

What is claimed is:

1. A glass substrate comprising at least one surface, wherein at least a portion of the surface is coated with a layer comprising at least one hydrocarbon, wherein the coated portion of the surface has a contact angle with deionized water ranging from about 15 degrees to about 95 degrees.

2. The glass substrate of claim 1, wherein the layer has a thickness ranging from about 1 nm to about 100 nm.

3. The glass substrate of claim 1, wherein the coated portion of the surface has a surface energy of less than about 65 mJ/m².

4. The glass substrate of claim 1, wherein the coated portion of the surface has a polar surface energy of less than about 25 mJ/m².

5. The glass substrate of claim 1, wherein the coated portion of the surface has a dispersive surface energy of greater than about 10 mJ/m².

6. The glass substrate of claim 1, wherein the layer is an amorphous hydrocarbon layer prepared by plasma deposition of at least one C₁-C₁₂ hydrocarbon.

7. A glass substrate comprising at least one surface, wherein at least a portion of the surface is coated with a layer comprising at least one hydrocarbon, wherein the coated portion of the surface has a surface energy of less than about 65 mJ/m².

8. The glass substrate of claim 7, wherein the coated portion of the surface has a polar surface energy of less than about 25 mJ/m².

9. The glass substrate of claim 7, wherein the coated portion of the surface has a dispersive surface energy of greater than about 10 mJ/m².

10. The glass substrate of claim 7, wherein the layer has a thickness ranging from about 1 nm to about 100 nm.

11. The glass substrate of claim 7, wherein the coated portion of the surface has a contact angle with deionized water ranging from about 15 degrees to about 95 degrees.

12. The glass substrate of claim 7, wherein the layer is an amorphous hydrocarbon layer prepared by plasma deposition of at least one C₁-C₁₂ hydrocarbon.

13. A method for treating a glass substrate, comprising:
bringing a surface of the glass substrate into contact with a plasma comprising at least one hydrocarbon for a residence time sufficient to form a coating on at least a portion of the surface, wherein the coating has at least one of the following properties:
(a) a surface energy of less than about 65 mJ/m²;
(b) a polar surface energy of less than about 25 mJ/m²;
(c) a dispersive surface energy of greater than about 10 mJ/m²; or
(d) a contact angle with deionized water ranging from about 15 degrees to about 95 degrees.

14. The method of claim 13, wherein the at least one hydrocarbon is chosen from C₁-C₁₂ hydrocarbons.

15. The method of claim 13, wherein the at least one hydrocarbon is chosen from C₁-C₆ volatile hydrocarbons.

16. The method of claim 13, wherein the plasma comprises from about 1% to about 20% percent by volume of the at least one hydrocarbon.

17. The method of claim 13, wherein the coating has a thickness ranging from about 1 nm to about 100 nm.

18. The method of claim 13, wherein bringing the surface of the glass substrate into contact with the plasma comprises scanning the surface with a plasma at a speed ranging from about 5 mm/s to about 100 mm/s.

19. The method of claim 13, further comprising removing the coating by dry or wet cleaning.

20. The method of claim 19, wherein after removing the coating, the surface of the glass substrate has a contact angle with deionized water of less than about 10 degrees.
